(19) United States
(12) Patent Application Publication
(10) Pub. No.: US 2026/0197244 A1
(43) Pub. Date: Jul. 9, 2026

(54) Method, System, and Computer Program Product for Spatial-Temporal Graph Sandwich Transformer for Traffic Flow Forecasting

(71) Applicant: Visa International Service Association, SanFrancisco, CA (US)

(72) Inventors: Yujie Fan, Cleveland Heights, OH (US); Michael Yeh, Newark, CA (US); Huiyuan Chen, San Jose, CA (US); Liang Wang, San Jose, CA (US); Zhongfang Zhuang, San Jose, CA (US); Junpeng Wang, Santa Clara, CA (US); Xin Dai, Fremont, CA (US); Yan Zheng, Los Gatos, CA (US); Wei Zhang, Fremont, CA (US)

(21) Appl. No.: 19/130,217

(22) PCT Filed: Nov. 17, 2023
(86) PCT No.: PCT/US23/80201

§ 371 Date: May 15, 2025

Related U.S. Application Data
(60) Provisional application No. 63/426,473, filed on Nov. 18, 2022.

(51) Int. Cl. H04L 41/147; H04L 41/16

(52) U.S. Cl. CPC H04L 41/147; H04L 41/16

(57) ABSTRACT

Methods, systems, and computer program products for traffic flow forecasting: obtain a graph representing a traffic network; obtain historical time-series traffic data associated with historical traffic conditions at a number of historical time steps in the traffic network; process, with each spatial-temporal graph sandwich transformer of at least one spatial-temporal graph sandwich transformer, the graph and the historical time-series traffic data to generate a sandwich transformer output, wherein each spatial-temporal graph sandwich transformer includes a top temporal transformer, a spatial transformer that receives, as an input, an output of the top temporal transformer and the graph, and a bottom temporal transformer that receives, as an input, an output of the spatial transformer; and generate, based on the sandwich transformer output from each spatial-temporal graph sandwich transformer, predicted time-series traffic data associated with predicted traffic conditions at a number of next time steps in the traffic network.

### CROSS-REFERENCE TO RELATED APPLICATIONS

This application is the United States national phase of International Application No. PCT/US23/80201, filed Nov. 17, 2023, and claims the benefit of U.S. Provisional Patent Application No. 63/426,473, filed Nov. 18, 2022, the disclosures of which are hereby incorporated by reference in their entireties.

### BACKGROUND

### 1. Technical Field

This disclosure relates generally to traffic flow forecasting and, in some non-limiting embodiments or aspects, to methods, systems, and computer program products for spatial-temporal graph sandwich transformer for traffic flow forecasting.

### 2. Technical Considerations

Traffic forecasting plays an essential role in modern intelligent transformation systems. Efficient and accurate flow forecasting allows better traffic management and planning. Generally, traffic flow forecasting aims to predict future traffic conditions by leveraging the historical time-series traffic input and the underlying traffic networks. Classic statistic models and sequence models primarily emphasize the time-series input but neglect the spatial correlations of traffic network, leaving huge room for improvements.

### SUMMARY

Accordingly, provided are improved methods, systems, and computer program products for traffic flow forecasting.

According to some non-limiting embodiments or aspects, provided is a method, including: obtaining, with at least one processor, a graph representing a traffic network; obtaining, with the at least one processor, historical time-series traffic data associated with historical traffic conditions at a number of historical time steps in the traffic network; processing, with the at least one processor, with each spatial-temporal graph sandwich transformer of at least one spatial-temporal graph sandwich transformer, the graph and the historical time-series traffic data to generate a sandwich transformer output, wherein each spatial-temporal graph sandwich transformer includes a top temporal transformer, a spatial transformer that receives, as an input, an output of the top temporal transformer and the graph, and a bottom temporal transformer that receives, as an input, an output of the spatial transformer; and generating, with the at least one processor, based on the sandwich transformer output from each spatial-temporal graph sandwich transformer, predicted time-series traffic data associated with predicted traffic conditions at a number of next time steps in the traffic network.

In some non-limiting embodiments or aspects, the at least one spatial-temporal graph sandwich transformer includes a plurality of spatial-temporal graph sandwich transformers.

In some non-limiting embodiments or aspects, the processing, with the at least one processor, with each spatial-temporal graph sandwich transformer, the graph and the historical time-series traffic data to generate the sandwich transformer output is performed in parallel with the plurality of spatial-temporal graph sandwich transformers.

In some non-limiting embodiments or aspects, the method further includes: providing, with the at least one processor, as an input to an input transformation layer including a fully connected layer, the historical time-series traffic data; and receiving, with the at least one processor, as an output from the input transformation layer, a hidden time-series embedding, wherein the top temporal transformer of each spatial-temporal graph sandwich transformer receives, as an input, the hidden time-series embedding.

In some non-limiting embodiments or aspects the generating, with the at least one processor, based on the sandwich transformer output from each spatial-temporal graph sandwich transformer, the predicted time-series traffic data associated with the predicted traffic conditions at the number of next time steps in the traffic network includes: concatenating the sandwich transformer output from each spatial-temporal graph sandwich transformer; providing, as an input to a multi-step prediction layer including at least two fully connected layers, the concatenated sandwich transformer output from each spatial-temporal graph sandwich transformer; and receiving, as an output from the multi-step prediction layer, the predicted time-series traffic data associated with the predicted traffic conditions at the number of next time steps in the traffic network.

In some non-limiting embodiments or aspects, the processing, with the at least one processor, with each spatial-temporal graph sandwich transformer, the graph and the historical time-series traffic data to generate the sandwich transformer output includes: applying, with the top temporal transformer, to an input of the top temporal transformer, a multi-head attention followed by a feed-forward network, with a residual connection and a layer normalization around each of the multi-head attention and the feed-forward network.

In some non-limiting embodiments or aspects, the processing, with the at least one processor, with each spatial-temporal graph sandwich transformer, the graph and the historical time-series traffic data to generate the sandwich transformer output includes: applying, with the spatial transformer, to the input to the spatial transformer including the output of the top temporal transformer and the graph, degree-based encoding and singular value decomposition (SVD)-based encoding; and applying, with the spatial transformer, spatial encoding as a bias term in a multi-headed attention applied to the input to the spatial transformer including the output of the top temporal transformer and the graph.

In some non-limiting embodiments or aspects, the input to the bottom temporal transformer including the output of the spatial transformer incudes a plurality of time-series sequences, and wherein the processing, with the at least one processor, with each spatial-temporal graph sandwich transformer, the graph and the historical time-series traffic data to generate the sandwich transformer output includes: appending, with the bottom temporal transformer, a special token to a beginning of each time-series sequence of the plurality of time-series sequences; and applying, with the bottom temporal transformer, to a plurality of token-appended time-series sequences, a multi-head attention followed by a feed-forward network, with a residual connection and a layer normalization around each of the multi-head attention and the feed-forward network.

In some non-limiting embodiments or aspects, the method further includes: training, with the at least one processor, the at least one spatial-temporal graph sandwich transformer according to a Huber loss function that depends on the predicted time-series traffic data associated with the predicted traffic conditions at the number of next time steps in the traffic network and actual time-series traffic data associated with actual traffic conditions at the number of next time steps in the traffic network.

In some non-limiting embodiments or aspects, the traffic network includes a payment network, wherein the graph includes a plurality of edges and a plurality of nodes for the plurality of edges, wherein the plurality of nodes is associated with a plurality of payment processing servers, and wherein the plurality of edges is associated with a plurality of connections between the plurality of payment processing servers.

According to some non-limiting embodiments or aspects, provided is a system, including: at least one processor programmed or configured to: obtain a graph representing a traffic network; obtain historical time-series traffic data associated with historical traffic conditions at a number of historical time steps in the traffic network; process, with each spatial-temporal graph sandwich transformer of at least one spatial-temporal graph sandwich transformer, the graph and the historical time-series traffic data to generate a sandwich transformer output, wherein each spatial-temporal graph sandwich transformer includes a top temporal transformer, a spatial transformer that receives, as an input, an output of the top temporal transformer and the graph, and a bottom temporal transformer that receives, as an input, an output of the spatial transformer; and generate, based on the sandwich transformer output from each spatial-temporal graph sandwich transformer, predicted time-series traffic data associated with predicted traffic conditions at a number of next time steps in the traffic network.

In some non-limiting embodiments or aspects, the at least one spatial-temporal graph sandwich transformer includes a plurality of spatial-temporal graph sandwich transformers.

In some non-limiting embodiments or aspects, the at least one processor is programmed or configured to process, with each spatial-temporal graph sandwich transformer, the graph and the historical time-series traffic data to generate the sandwich transformer output in parallel with the plurality of spatial-temporal graph sandwich transformers.

In some non-limiting embodiments or aspects, the at least one processor is further programmed or configured to: provide, as an input to an input transformation layer including a fully connected layer, the historical time-series traffic data; and receive, as an output from the input transformation layer, a hidden time-series embedding, wherein the top temporal transformer of each spatial-temporal graph sandwich transformer receives, as an input, the hidden time-series embedding.

In some non-limiting embodiments or aspects, the at least one processor is programmed or configured to generate, based on the sandwich transformer output from each spatial-temporal graph sandwich transformer, the predicted time-series traffic data associated with the predicted traffic conditions at the number of next time steps in the traffic network by: concatenating the sandwich transformer output from each spatial-temporal graph sandwich transformer; providing, as an input to a multi-step prediction layer including at least two fully connected layers, the concatenated sandwich transformer output from each spatial-temporal graph sandwich transformer; and receiving, as an output from the multi-step prediction layer, the predicted time-series traffic data associated with the predicted traffic conditions at the number of next time steps in the traffic network.

In some non-limiting embodiments or aspects, the at least one processor is programmed or configured to process, with each spatial-temporal graph sandwich transformer, the graph and the historical time-series traffic data to generate the sandwich transformer output by: applying, with the top temporal transformer, to an input of the top temporal transformer, a multi-head attention followed by a feed-forward network, with a residual connection and a layer normalization around each of the multi-head attention and the feed-forward network.

In some non-limiting embodiments or aspects, the at least one processor is programmed or configured to process, with each spatial-temporal graph sandwich transformer, the graph and the historical time-series traffic data to generate the sandwich transformer output by: applying, with the spatial transformer, to the input to the spatial transformer including the output of the top temporal transformer and the graph, degree-based encoding and singular value decomposition (SVD)-based encoding; and applying, with the spatial transformer, spatial encoding as a bias term in a multi-headed attention applied to the input to the spatial transformer including the output of the top temporal transformer and the graph.

In some non-limiting embodiments or aspects, the input to the bottom temporal transformer including the output of the spatial transformer incudes a plurality of time-series sequences, and wherein the at least one processor is programmed or configured to process, with each spatial-temporal graph sandwich transformer, the graph and the historical time-series traffic data to generate the sandwich transformer output by: appending, with the bottom temporal transformer, a special token to a beginning of each time-series sequence of the plurality of time-series sequences; and applying, with the bottom temporal transformer, to a plurality of token-appended time-series sequences, a multi-head attention followed by a feed-forward network, with a residual connection and a layer normalization around each of the multi-head attention and the feed-forward network.

In some non-limiting embodiments or aspects, the at least one processor is further programmed or configured to: train the at least one spatial-temporal graph sandwich transformer according to a Huber loss function that depends on the predicted time-series traffic data associated with the predicted traffic conditions at the number of next time steps in the traffic network and actual time-series traffic data associated with actual traffic conditions at the number of next time steps in the traffic network.

In some non-limiting embodiments or aspects, the traffic network includes a payment network, wherein the graph includes a plurality of edges and a plurality of nodes for the plurality of edges, wherein the plurality of nodes is associated with a plurality of payment processing servers, and wherein the plurality of edges is associated with a plurality of connections between the plurality of payment processing servers.

According to some non-limiting embodiments or aspects, provided is a computer program product including a non-transitory computer readable medium including program instructions which, when executed by at least one processor, cause the at least one processor to: obtain a graph representing a traffic network; obtain historical time-series traffic data associated with historical traffic conditions at a number of historical time steps in the traffic network; process, with each spatial-temporal graph sandwich transformer of at least one spatial-temporal graph sandwich transformer, the graph and the historical time-series traffic data to generate a sandwich transformer output, wherein each spatial-temporal graph sandwich transformer includes a top temporal transformer, a spatial transformer that receives, as an input, an output of the top temporal transformer and the graph, and a bottom temporal transformer that receives, as an input, an output of the spatial transformer; and generate, based on the sandwich transformer output from each spatial-temporal graph sandwich transformer, predicted time-series traffic data associated with predicted traffic conditions at a number of next time steps in the traffic network.

In some non-limiting embodiments or aspects, the at least one spatial-temporal graph sandwich transformer includes a plurality of spatial-temporal graph sandwich transformers.

In some non-limiting embodiments or aspects, the program instructions, when executed by the at least one processor, cause the at least one processor to process, with each spatial-temporal graph sandwich transformer, the graph and the historical time-series traffic data to generate the sandwich transformer output in parallel with the plurality of spatial-temporal graph sandwich transformers.

In some non-limiting embodiments or aspects, the program instructions, when executed by the at least one processor, further cause the at least one processor to: provide, as an input to an input transformation layer including a fully connected layer, the historical time-series traffic data; and receive, as an output from the input transformation layer, a hidden time-series embedding, wherein the top temporal transformer of each spatial-temporal graph sandwich transformer receives, as an input, the hidden time-series embedding.

In some non-limiting embodiments or aspects, the program instructions, when executed by the at least one processor, cause the at least one processor to generate, based on the sandwich transformer output from each spatial-temporal graph sandwich transformer, the predicted time-series traffic data associated with the predicted traffic conditions at the number of next time steps in the traffic network by: concatenating the sandwich transformer output from each spatial-temporal graph sandwich transformer; providing, as an input to a multi-step prediction layer including at least two fully connected layers, the concatenated sandwich transformer output from each spatial-temporal graph sandwich transformer; and receiving, as an output from the multi-step prediction layer, the predicted time-series traffic data associated with the predicted traffic conditions at the number of next time steps in the traffic network.

In some non-limiting embodiments or aspects, the program instructions, when executed by the at least one processor, cause the at least one processor to process, with each spatial-temporal graph sandwich transformer, the graph and the historical time-series traffic data to generate the sandwich transformer output by: applying, with the top temporal transformer, to an input of the top temporal transformer, a multi-head attention followed by a feed-forward network, with a residual connection and a layer normalization around each of the multi-head attention and the feed-forward network.

In some non-limiting embodiments or aspects, the program instructions, when executed by the at least one processor, cause the at least one processor to process, with each spatial-temporal graph sandwich transformer, the graph and the historical time-series traffic data to generate the sandwich transformer output by: applying, with the spatial transformer, to the input to the spatial transformer including the output of the top temporal transformer and the graph, degree-based encoding and singular value decomposition (SVD)-based encoding; and applying, with the spatial transformer, spatial encoding as a bias term in a multi-headed attention applied to the input to the spatial transformer including the output of the top temporal transformer and the graph.

In some non-limiting embodiments or aspects, the input to the bottom temporal transformer including the output of the spatial transformer incudes a plurality of time-series sequences, and wherein the program instructions, when executed by the at least one processor, cause the at least one processor to process, with each spatial-temporal graph sandwich transformer, the graph and the historical time-series traffic data to generate the sandwich transformer output by: appending, with the bottom temporal transformer, a special token to a beginning of each time-series sequence of the plurality of time-series sequences; and applying, with the bottom temporal transformer, to a plurality of token-appended time-series sequences, a multi-head attention followed by a feed-forward network, with a residual connection and a layer normalization around each of the multi-head attention and the feed-forward network.

In some non-limiting embodiments or aspects, the program instructions, when executed by the at least one processor, further cause the at least one processor to: train the at least one spatial-temporal graph sandwich transformer according to a Huber loss function that depends on the predicted time-series traffic data associated with the predicted traffic conditions at the number of next time steps in the traffic network and actual time-series traffic data associated with actual traffic conditions at the number of next time steps in the traffic network.

In some non-limiting embodiments or aspects, the traffic network includes a payment network, wherein the graph includes a plurality of edges and a plurality of nodes for the plurality of edges, wherein the plurality of nodes is associated with a plurality of payment processing servers, and wherein the plurality of edges is associated with a plurality of connections between the plurality of payment processing servers.

Further non-limiting embodiments or aspects are set forth in the following numbered clauses:
Clause 1: A method, comprising: obtaining, with at least one processor, a graph representing a traffic network; obtaining, with the at least one processor, historical time-series traffic data associated with historical traffic conditions at a number of historical time steps in the traffic network; processing, with the at least one processor, with each spatial-temporal graph sandwich transformer of at least one spatial-temporal graph sandwich transformer, the graph and the historical time-series traffic data to generate a sandwich transformer output, wherein each spatial-temporal graph sandwich transformer includes a top temporal transformer, a spatial transformer that receives, as an input, an output of the top temporal transformer and the graph, and a bottom temporal transformer that receives, as an input, an output of the spatial transformer; and generating, with the at least one processor, based on the sandwich transformer output from each spatial-temporal graph sandwich transformer, predicted time-series traffic data associated with predicted traffic conditions at a number of next time steps in the traffic network.
Clause 2: The method of clause 1, wherein the at least one spatial-temporal graph sandwich transformer includes a plurality of spatial-temporal graph sandwich transformers.
Clause 3: The method of clause 1 or 2, wherein the processing, with the at least one processor, with each spatial-temporal graph sandwich transformer, the graph and the historical time-series traffic data to generate the sandwich transformer output is performed in parallel with the plurality of spatial-temporal graph sandwich transformers.
Clause 4: The method of any of clauses 1-3, further comprising: providing, with the at least one processor, as an input to an input transformation layer including a fully connected layer, the historical time-series traffic data; and receiving, with the at least one processor, as an output from the input transformation layer, a hidden time-series embedding, wherein the top temporal transformer of each spatial-temporal graph sandwich transformer receives, as an input, the hidden time-series embedding.
Clause 5: The method of any of clauses 1-4, wherein the generating, with the at least one processor, based on the sandwich transformer output from each spatial-temporal graph sandwich transformer, the predicted time-series traffic data associated with the predicted traffic conditions at the number of next time steps in the traffic network includes: concatenating the sandwich transformer output from each spatial-temporal graph sandwich transformer; providing, as an input to a multi-step prediction layer including at least two fully connected layers, the concatenated sandwich transformer output from each spatial-temporal graph sandwich transformer; and receiving, as an output from the multi-step prediction layer, the predicted time-series traffic data associated with the predicted traffic conditions at the number of next time steps in the traffic network.
Clause 6: The method of any of clauses 1-5, wherein the processing, with the at least one processor, with each spatial-temporal graph sandwich transformer, the graph and the historical time-series traffic data to generate the sandwich transformer output includes: applying, with the top temporal transformer, to an input of the top temporal transformer, a multi-head attention followed by a feed-forward network, with a residual connection and a layer normalization around each of the multi-head attention and the feed-forward network.
Clause 7: The method of any of clauses 1-6, wherein the processing, with the at least one processor, with each spatial-temporal graph sandwich transformer, the graph and the historical time-series traffic data to generate the sandwich transformer output includes: applying, with the spatial transformer, to the input to the spatial transformer including the output of the top temporal transformer and the graph, degree-based encoding and singular value decomposition (SVD)-based encoding; and applying, with the spatial transformer, spatial encoding as a bias term in a multi-headed attention applied to the input to the spatial transformer including the output of the top temporal transformer and the graph.
Clause 8: The method of any of clauses 1-7, wherein the input to the bottom temporal transformer including the output of the spatial transformer incudes a plurality of time-series sequences, and wherein the processing, with the at least one processor, with each spatial-temporal graph sandwich transformer, the graph and the historical time-series traffic data to generate the sandwich transformer output includes: appending, with the bottom temporal transformer, a special token to a beginning of each time-series sequence of the plurality of time-series sequences; and applying, with the bottom temporal transformer, to a plurality of token-appended time-series sequences, a multi-head attention followed by a feed-forward network, with a residual connection and a layer normalization around each of the multi-head attention and the feed-forward network.
Clause 9: The method of any of clauses 1-8, further comprising: training, with the at least one processor, the at least one spatial-temporal graph sandwich transformer according to a Huber loss function that depends on the predicted time-series traffic data associated with the predicted traffic conditions at the number of next time steps in the traffic network and actual time-series traffic data associated with actual traffic conditions at the number of next time steps in the traffic network.
Clause 10: The method of any of clauses 1-9, wherein the traffic network includes a payment network, wherein the graph includes a plurality of edges and a plurality of nodes for the plurality of edges, wherein the plurality of nodes is associated with a plurality of payment processing servers, and wherein the plurality of edges is associated with a plurality of connections between the plurality of payment processing servers.
Clause 11: A system, comprising: at least one processor programmed or configured to: obtain a graph representing a traffic network; obtain historical time-series traffic data associated with historical traffic conditions at a number of historical time steps in the traffic network; process, with each spatial-temporal graph sandwich transformer of at least one spatial-temporal graph sandwich transformer, the graph and the historical time-series traffic data to generate a sandwich transformer output, wherein each spatial-temporal graph sandwich transformer includes a top temporal transformer, a spatial transformer that receives, as an input, an output of the top temporal transformer and the graph, and a bottom temporal transformer that receives, as an input, an output of the spatial transformer; and generate, based on the sandwich transformer output from each spatial-temporal graph sandwich transformer, predicted time-series traffic data associated with predicted traffic conditions at a number of next time steps in the traffic network.
Clause 12: The system of clause 11, wherein the at least one spatial-temporal graph sandwich transformer includes a plurality of spatial-temporal graph sandwich transformers.
Clause 13: The system of clause 11 or 12, wherein the at least one processor is programmed or configured to process, with each spatial-temporal graph the sandwich transformer output in parallel with the plurality of spatial-temporal graph sandwich transformers.
Clause 14: The system of any of clauses 11-13, wherein the at least one processor is further programmed or configured to: provide, as an input to an input transformation layer including a fully connected layer, the historical time-series traffic data; and receive, as an output from the input transformation layer, a hidden time-series embedding, wherein the top temporal transformer of each spatial-temporal graph sandwich transformer receives, as an input, the hidden time-series embedding.
Clause 15: The system of any of clauses 11-14, wherein the at least one processor is programmed or configured to generate, based on the sandwich transformer output from each spatial-temporal graph sandwich transformer, the predicted time-series traffic data associated with the predicted traffic conditions at the number of next time steps in the traffic network by: concatenating the sandwich transformer output from each spatial-temporal graph sandwich transformer; providing, as an input to a multi-step prediction layer including at least two fully connected layers, the concatenated sandwich transformer output from each spatial-temporal graph sandwich transformer; and receiving, as an output from the multi-step prediction layer, the predicted time-series traffic data associated with the predicted traffic conditions at the number of next time steps in the traffic network.
Clause 16: The system of any of clauses 11-15, wherein the at least one processor is programmed or configured to process, with each spatial-temporal graph sandwich transformer, the graph and the historical time-series traffic data to generate the sandwich transformer output by: applying, with the top temporal transformer, to an input of the top temporal transformer, a multi-head attention followed by a feed-forward network, with a residual connection and a layer normalization around each of the multi-head attention and the feed-forward network.
Clause 17: The system of any of clauses 11-16, wherein the at least one processor is programmed or configured to process, with each spatial-temporal graph sandwich transformer, the graph and the historical time-series traffic data to generate the sandwich transformer output by: applying, with the spatial transformer, to the input to the spatial transformer including the output of the top temporal transformer and the graph, degree-based encoding and singular value decomposition (SVD)-based encoding; and applying, with the spatial transformer, spatial encoding as a bias term in a multi-headed attention applied to the input to the spatial transformer including the output of the top temporal transformer and the graph.
Clause 18: The system of any of clauses 11-17, wherein the input to the bottom temporal transformer including the output of the spatial transformer incudes a plurality of time-series sequences, and wherein the at least one processor is programmed or configured to process, with each spatial-temporal graph sandwich transformer, the graph and the historical time-series traffic data to generate the sandwich transformer output by: appending, with the bottom temporal transformer, a special token to a beginning of each time-series sequence of the plurality of time-series sequences; and applying, with the bottom temporal transformer, to a plurality of token-appended time-series sequences, a multi-head attention followed by a feed-forward network, with a residual connection and a layer normalization around each of the multi-head attention and the feed-forward network.
Clause 19: The system of any of clauses 11-18, wherein the at least one processor is further programmed or configured to: train the at least one spatial-temporal graph sandwich transformer according to a Huber loss function that depends on the predicted time-series traffic data associated with the predicted traffic conditions at the number of next time steps in the traffic network and actual time-series traffic data associated with actual traffic conditions at the number of next time steps in the traffic network.
Clause 20: The system of any of clauses 11-19, wherein the traffic network includes a payment network, wherein the graph includes a plurality of edges and a plurality of nodes for the plurality of edges, wherein the plurality of nodes is associated with a plurality of payment processing servers, and wherein the plurality of edges is associated with a plurality of connections between the plurality of payment processing servers.
Clause 21: A computer program product including a non-transitory computer readable medium including program instructions which, when executed by at least one processor, cause the at least one processor to: obtain a graph representing a traffic network; obtain historical time-series traffic data associated with historical traffic conditions at a number of historical time steps in the traffic network; process, with each spatial-temporal graph sandwich transformer of at least one spatial-temporal graph a sandwich transformer output, wherein each spatial-temporal graph sandwich transformer includes a top temporal transformer, a spatial transformer that receives, as an input, an output of the top temporal transformer and the graph, and a bottom temporal transformer that receives, as an input, an output of the spatial transformer; and generate, based on the sandwich transformer output from each spatial-temporal graph sandwich transformer, predicted time-series traffic data associated with predicted traffic conditions at a number of next time steps in the traffic network.
Clause 22: The computer program product of clause 21, wherein the at least one spatial-temporal graph sandwich transformer includes a plurality of spatial-temporal graph sandwich transformers.
Clause 23: The computer program product of clause 21 or 22, wherein the program instructions, when executed by the at least one processor, cause the at least one processor to process, with each spatial-temporal graph sandwich transformer, the graph and the historical time-series traffic data to generate the sandwich transformer output in parallel with the plurality of spatial-temporal graph sandwich transformers.
Clause 24: The computer program product of any of clauses 21-23, wherein the program instructions, when executed by the at least one processor, further cause the at least one processor to: provide, as an input to an input transformation layer including a fully connected layer, the historical time-series traffic data; and receive, as an output from the input transformation layer, a hidden time-series embedding, wherein the top temporal transformer of each spatial-temporal graph sandwich transformer receives, as an input, the hidden time-series embedding.
Clause 25: The computer program product of any of clauses 21-24, wherein the program instructions, when executed by the at least one processor, cause the at least one processor to generate, based on the sandwich transformer output from each spatial-temporal graph sandwich transformer, the predicted time-series traffic data associated with the predicted traffic conditions at the number of next time steps in the traffic network by: concatenating the sandwich transformer output from each spatial-temporal graph sandwich transformer; providing, as an input to a multi-step prediction layer including at least two fully connected layers, the concatenated sandwich transformer output from each spatial-temporal graph sandwich transformer; and receiving, as an output from the multi-step prediction layer, the predicted time-series traffic data associated with the predicted traffic conditions at the number of next time steps in the traffic network.
Clause 26: The computer program product of any of clauses 21-25, wherein the program instructions, when executed by the at least one processor, cause the at least one processor to process, with each spatial-temporal graph sandwich transformer, the graph and the historical time-series traffic data to generate the sandwich transformer output by: applying, with the top temporal transformer, to an input of the top temporal transformer, a multi-head attention followed by a feed-forward network, with a residual connection and a layer normalization around each of the multi-head attention and the feed-forward network.
Clause 27: The computer program product of any of clauses 21-26, wherein the program instructions, when executed by the at least one processor, cause the at least one processor to process, with each spatial-temporal graph sandwich transformer, the graph and the historical time-series traffic data to generate the sandwich transformer output by: applying, with the spatial transformer, to the input to the spatial transformer including the output of the top temporal transformer and the graph, degree-based encoding and singular value decomposition (SVD)-based encoding; and applying, with the spatial transformer, spatial encoding as a bias term in a multi-headed attention applied to the input to the spatial transformer including the output of the top temporal transformer and the graph.
Clause 28: The computer program product of any of clauses 21-27, wherein the input to the bottom temporal transformer including the output of the spatial transformer incudes a plurality of time-series sequences, and wherein the program instructions, when executed by the at least one processor, cause the at least one processor to process, with each spatial-temporal graph sandwich transformer, the graph and the historical time-series traffic data to generate the sandwich transformer output by: appending, with the bottom temporal transformer, a special token to a beginning of each time-series sequence of the plurality of time-series sequences; and applying, with the bottom temporal transformer, to a plurality of token-appended time-series sequences, a multi-head attention followed by a feed-forward network, with a residual connection and a layer normalization around each of the multi-head attention and the feed-forward network.
Clause 29: The computer program product of any of clauses 21-28, wherein the program instructions, when executed by the at least one processor, further cause the at least one processor to: train the at least one spatial-temporal graph sandwich transformer according to a Huber loss function that depends on the predicted time-series traffic data associated with the predicted traffic conditions at the number of next time steps in the traffic network and actual time-series traffic data associated with actual traffic conditions at the number of next time steps in the traffic network.
Clause 30: The computer program product of any of clauses 21-29, wherein the traffic network includes a payment network, wherein the graph includes a plurality of edges and a plurality of nodes for the plurality of edges, wherein the plurality of nodes is associated with a plurality of payment processing servers, and wherein the plurality of edges is associated with a plurality of connections between the plurality of payment processing servers.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosed subject matter.

### BRIEF DESCRIPTION OF THE DRAWINGS

Additional advantages and details are explained in greater detail below with reference to the exemplary embodiments that are illustrated in the accompanying schematic figures, in which:

FIG. 1 is a diagram of non-limiting embodiments or aspects of an environment in which systems, devices, products, apparatus, and/or methods, described herein, may be implemented;

FIG. 2 is a diagram of non-limiting embodiments or aspects of components of one or more devices and/or one or more systems of FIG. 1;

FIG. 3 is a flow diagram of a method for a spatial-temporal graph sandwich transformer (STGST), according to non-limiting embodiments or aspects;

FIG. 4 illustrates an architecture of non-limiting embodiments or aspects of an STGST;

FIG. 5 is a table of dataset statistics of two traffic datasets selected for experiments;

FIG. 6 is a table including a comparison of performance between non-limiting embodiments or aspects of an STGST and baselines;

FIG. 7 is graphs of a comparison of performance between STGST variants; and

FIG. 8 is graphs illustrating a training loss and a validation loss of STGST on the two traffic datasets selected for experiments; and

FIG. 9 is graphs illustrating an effect of a model depth and a hidden dimension on STGST.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the embodiments as they are oriented in the drawing figures. However, it is to be understood that the embodiments may assume various alternative variations and step sequences, except where expressly specified to the contrary. It is also to be understood that the specific devices and processes illustrated in the attached drawings, and described in the following specification, are simply exemplary embodiments or aspects of the disclosed subject matter. Hence, specific dimensions and other physical characteristics related to the embodiments or aspects disclosed herein are not to be considered as limiting.

It is to be understood that the present disclosure may assume various alternative variations and step sequences, except where expressly specified to the contrary. It is also to be understood that the specific devices and processes illustrated in the attached drawings, and described in the following specification, are simply exemplary and non-limiting embodiments or aspects. Hence, specific dimensions and other physical characteristics related to the embodiments or aspects disclosed herein are not to be considered as limiting.

Some non-limiting embodiments or aspects may be described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. In addition, reference to an action being “based on” a condition may refer to the action being “in response to” the condition. For example, the phrases “based on” and “in response to” may, in some non-limiting embodiments or aspects, refer to a condition for automatically triggering an action (e.g., a specific operation of an electronic device, such as a computing device, a processor, and/or the like).

As used herein, the term “communication” may refer to the reception, receipt, transmission, transfer, provision, and/or the like of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit processes information received from the first unit and communicates the processed information to the second unit. In some non-limiting embodiments or aspects, a message may refer to a network packet (e.g., a data packet and/or the like) that includes data. It will be appreciated that numerous other arrangements are possible.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. A computing device may also be a desktop computer or other form of non-mobile computer.

As used herein, the term “server” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, point-of-sale (POS) devices, mobile devices, etc.) directly or indirectly communicating in the network environment may constitute a “system.”

As used herein, the term “system” may refer to one or more computing devices or combinations of computing devices and/or components of such (e.g., processors, servers, client devices, software applications, and/or the like). Reference to “a device,” “a server,” “a processor,” and/or the like, as used herein, may refer to a previously-recited device, server, or processor that is recited as performing a previous step or function, a different device, server, or processor, and/or a combination of devices, servers, and/or processors. For example, as used in the specification and the claims, a first device, a first server, or a first processor that is recited as performing a first step or a first function may refer to the same or different device, server, or processor recited as performing a second step or a second function.

As used herein, the term “transaction service provider” may refer to an entity that receives transaction authorization requests from merchants or other entities and provides guarantees of payment, in some cases through an agreement between the transaction service provider and an issuer institution. For example, a transaction service provider may include a payment network such as Visa® or any other entity that processes transactions. The term “transaction processing system” may refer to one or more computing devices operated by or on behalf of a transaction service provider, such as a transaction processing server executing one or more software applications. A transaction processing system may include one or more processors and, in some non-limiting embodiments, may be operated by or on behalf of a transaction service provider.

As used herein, the term “account identifier” may include one or more primary account numbers (PANs), tokens, or other identifiers associated with a customer account. The term “token” may refer to an identifier that is used as a substitute or replacement identifier for an original account identifier, such as a PAN. Account identifiers may be alphanumeric or any combination of characters and/or symbols. Tokens may be associated with a PAN or other original account identifier in one or more data structures (e.g., one or more databases and/or the like) such that they may be used to conduct a transaction without directly using the original account identifier. In some examples, an original account identifier, such as a PAN, may be associated with a plurality of tokens for different individuals or purposes.

As used herein, the terms “issuer institution,” “portable financial device issuer,” “issuer,” or “issuer bank” may refer to one or more entities that provide one or more accounts to a user (e.g., a customer, a consumer, an entity, an organization, and/or the like) for conducting transactions (e.g., payment transactions), such as initiating credit card payment transactions and/or debit card payment transactions. For example, an issuer institution may provide an account identifier, such as a PAN, to a user that uniquely identifies one or more accounts associated with that user. The account identifier may be embodied on a portable financial device, such as a physical financial instrument (e.g., a payment card), and/or may be electronic and used for electronic payments. In some non-limiting embodiments or aspects, an issuer institution may be associated with a bank identification number (BIN) that uniquely identifies the issuer institution. As used herein, the term “issuer institution system” may refer to one or more computer systems operated by or on behalf of an issuer institution, such as a server computer executing one or more software applications. For example, an issuer institution system may include one or more authorization servers for authorizing a payment transaction.

As used herein, the term “merchant” may refer to an individual or entity that provides goods and/or services, or access to goods and/or services, to users (e.g. customers) based on a transaction (e.g. a payment transaction). As used herein, the terms “merchant” or “merchant system” may also refer to one or more computer systems, computing devices, and/or software application operated by or on behalf of a merchant, such as a server computer executing one or more software applications. A “point-of-sale (POS) system,” as used herein, may refer to one or more computers and/or peripheral devices used by a merchant to engage in payment transactions with users, including one or more card readers, near-field communication (NFC) receivers, radio frequency identification (RFID) receivers, and/or other contactless transceivers or receivers, contact-based receivers, payment terminals, computers, servers, input devices, and/or other like devices that can be used to initiate a payment transaction. A POS system may be part of a merchant system. A merchant system may also include a merchant plug-in for facilitating online, Internet-based transactions through a merchant webpage or software application. A merchant plug-in may include software that runs on a merchant server or is hosted by a third-party for facilitating such online transactions.

As used herein, the term “payment device” may refer to a portable financial device, an electronic payment device, a payment card (e.g., a credit or debit card), a gift card, a smartcard, smart media, a payroll card, a healthcare card, a wristband, a machine-readable medium containing account information, a keychain device or fob, an RFID transponder, a retailer discount or loyalty card, a cellular phone, an electronic wallet mobile application, a PDA, a pager, a security card, a computer, an access card, a wireless terminal, a transponder, and/or the like. In some non-limiting embodiments or aspects, the payment device may include volatile or nonvolatile memory to store information (e.g., an account identifier, a name of the account holder, and/or the like).

As used herein, the term “acquirer” may refer to an entity licensed by the transaction service provider and/or approved by the transaction service provider to originate transactions using a portable financial device of the transaction service provider. Acquirer may also refer to one or more computer systems operated by or on behalf of an acquirer, such as a server computer executing one or more software applications (e.g., “acquirer server”). An “acquirer” may be a merchant bank, or in some cases, the merchant system may be the acquirer. The transactions may include original credit transactions (OCTs) and account funding transactions (AFTs). The acquirer may be authorized by the transaction service provider to sign merchants of service providers to originate transactions using a portable financial device of the transaction service provider. The acquirer may contract with payment facilitators to enable the facilitators to sponsor merchants. The acquirer may monitor compliance of the payment facilitators in accordance with regulations of the transaction service provider. The acquirer may conduct due diligence of payment facilitators and ensure that proper due diligence occurs before signing a sponsored merchant. Acquirers may be liable for all transaction service provider programs that they operate or sponsor. Acquirers may be responsible for the acts of its payment facilitators and the merchants it or its payment facilitators sponsor.

As used herein, the term “payment gateway” may refer to an entity and/or a payment processing system operated by or on behalf of such an entity (e.g., a merchant service provider, a payment service provider, a payment facilitator, a payment facilitator that contracts with an acquirer, a payment aggregator, and/or the like), which provides payment services (e.g., transaction service provider payment services, payment processing services, and/or the like) to one or more merchants. The payment services may be associated with the use of portable financial devices managed by a transaction service provider. As used herein, the term “payment gateway system” may refer to one or more computer systems, computer devices, servers, groups of servers, and/or the like operated by or on behalf of a payment gateway.

Through modeling a traffic network as a graph with nodes and edges representing traffic sensors and spatial connectivity of the traffic sensors, spatial-temporal graph models have been studied intensively and have achieved state-of-the-art performance in traffic flow forecasting. For example, existing works explore graph neural networks (GNNs), such as spatial/spectral graph convolutional networks (GCNs) and graph attention networks (GATs), to characterize spatial dependency by introducing inherent structural information of the traffic network. While in the temporal dimension, existing works may either apply recurrent neural networks (RNNs), such as gated recurrent units (GRUs) and long-short term memory (LSTM), or convolution-based sequence learning models, such as temporal convolutional networks (TCNs), to describe the temporal dependency of the time-series traffic data. By integrating the output of spatial and temporal domains, existing works may be able to jointly capture the spatial-temporal correlations. Although existing spatial-temporal models have demonstrated superior performance than sequence model-based forecasting, these existing spatial-temporal models are still restricted in at least the following three aspects: limited-range temporal dependency, shallow spatial dependency, and faint spatial-temporal interaction.

For example, RNNs used in the temporal domain may process the time-series input step-by-step and retain the past information in the hidden states. However, RNNs are faced with the long-term dependency problem. When handling long sequences, the probability of keeping the context from a word far away from the current word being processed decreases exponentially with the distance from the word. The same problem of RNNs that happens in the natural language processing (NLP) domain generally happens in the traffic forecasting scenario. Such a limitation leads to the limited-range temporal dependency described, restricting its use when long-range historical time-series data is needed. In the spatial domain, GNNs used in existing works typically follow a message-passing scheme that iteratively aggregates neighbor information. However, GNNs have been proven to suffer from an over-smoothing problem (e.g., node representations become indistinguishable with increased model depth, etc.) due to repeated local aggregation, leading to inferior performance in practice. Such inherent drawbacks limit the GNNs' ability to learn deep and global spatial features, resulting in shallow spatial dependency captured in existing works. Furthermore, most existing methods characterize the temporal dependency and spatial dependency separately and combine them either serially or in parallel. These designs may weaken the connection between spatial and temporal domains and yield faint spatial-temporal interaction.

Non-limiting embodiments or aspects of the present disclosure may provide methods, systems, and/or computer program products that obtain a graph representing a traffic network; obtain historical time-series traffic data associated with historical traffic conditions at a number of historical time steps in the traffic network; process, with each spatial-temporal graph sandwich transformer of at least one spatial-temporal graph sandwich transformer, the graph and the historical time-series traffic data to generate a sandwich transformer output, wherein each spatial-temporal graph sandwich transformer includes a top temporal transformer, a spatial transformer that receives, as an input, an output of the top temporal transformer and the graph, and a bottom temporal transformer that receives, as an input, an output of the spatial transformer; and generate, based on the sandwich transformer output from each spatial-temporal graph sandwich transformer, predicted time-series traffic data associated with predicted traffic conditions at a number of next time steps in the traffic network. For example, non-limiting embodiments or aspects of the present disclosure may provide two temporal transformers and a spatial transformer to characterize long-range temporal dependency and deep spatial dependency, respectively; and structure the temporal and spatial transformers in a sandwich manner to capture prosperous spatial-temporal interactions.

As an example, non-limiting embodiments or aspects of the present disclosure may provide an STGST for traffic flow forecasting that includes a sandwich transformer cluster including a set of STGSTs. Each sandwich transformer may include a top temporal transformer and a bottom temporal transformer as “buns”, and a spatial transformer as “meat”. The two temporal transformers may alleviate the limited-range temporal dependency. The time-series input may be processed as a whole rather than step-by-step in the temporal transformer, enabling non-limiting embodiments or aspects to be less likely to forget information and to be able to capture long-range temporal dependency. The spatial transformer may accommodate the shallow spatial dependency by equipping the spatial transformer with structure encoding and spatial encoding to incorporate graph structural information in transformer architecture. Applying the designed spatial transformer enables non-limiting embodiments or aspects to capture deep and global spatial dependency. To cope with the faint spatial-temporal interaction, the temporal and spatial transformers may be structured in a “sandwich” manner, which can capture prosperous spatial-temporal interactions. Additionally, assembling several sandwich transformers in a cluster may further strengthen the spatial-temporal correlations. Comprehensive experiments conducted on public traffic benchmarks are described herein below with promising results that demonstrate the superior performance of an STGST according to non-limiting embodiments or aspects by comparison with ten state-of-the-art baselines.

In this way, non-limiting embodiments or aspects of the present disclosure may enable (i) time-series input to be processed as a whole rather than step by step in the temporal transformer, making it unlikely to forget information and be able to capture long-range temporal dependency; (ii) capture of deep and global spatial dependency; and (iii) capture of prosperous spatial-temporal interactions. Moreover, assembling several sandwich transformers in a cluster may further strengthen the spatial-temporal correlations.

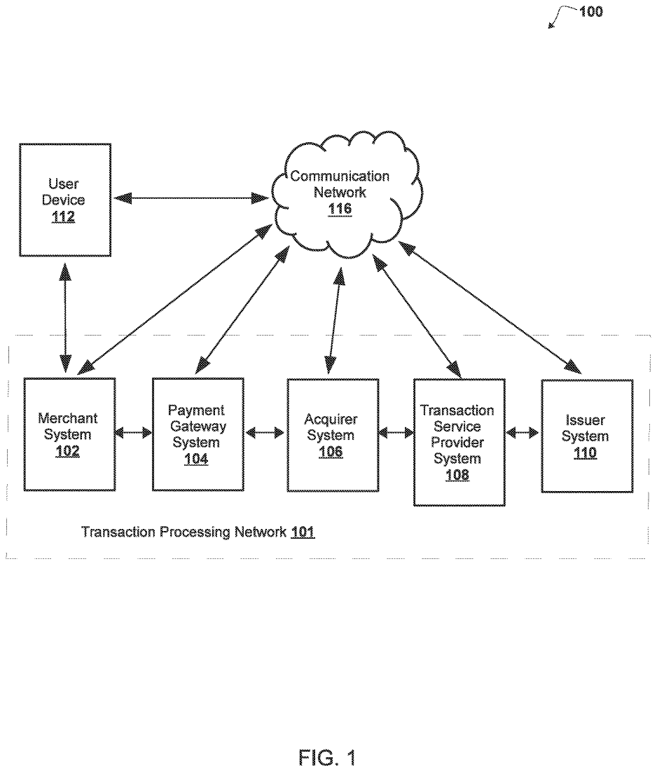

Referring now to FIG. 1, FIG. 1 is a diagram of an example environment 100 in which devices, systems, methods, and/or products described herein may be implemented. As shown in FIG. 1, environment 100 includes transaction processing network 101, which may include merchant system 102, payment gateway system 104, acquirer system 106, transaction service provider system 108, issuer system 110, user device 112, and/or communication network 116. Transaction processing network 101, merchant system 102, payment gateway system 104, acquirer system 106, transaction service provider system 108, issuer system 110, and/or user device 112, may interconnect (e.g., establish a connection to communicate, etc.) via wired connections, wireless connections, or a combination of wired and wireless connections.

Merchant system 102 may include one or more devices capable of receiving information and/or data from payment gateway system 104, acquirer system 106, transaction service provider system 108, issuer system 110, and/or user device 112 (e.g., via communication network 116, etc.) and/or communicating information and/or data to payment gateway system 104, acquirer system 106, transaction service provider system 108, issuer system 110, and/or user device 112 (e.g., via communication network 116, etc.). Merchant system 102 may include a device capable of receiving information and/or data from user device 112 via a communication connection (e.g., an NFC communication connection, an RFID communication connection, a Bluetooth® communication connection, etc.) with user device 112 and/or communicating information and/or data to user device 112 via the communication connection. For example, merchant system 102 may include a computing device, such as a server, a group of servers, a client device, a group of client devices, and/or other like devices. In some non-limiting embodiments or aspects, merchant system 102 may be associated with a merchant as described herein. In some non-limiting embodiments or aspects, merchant system 102 may include one or more devices, such as computers, computer systems, and/or peripheral devices capable of being used by a merchant to conduct a payment transaction with a user. For example, merchant system 102 may include a POS device and/or a POS system.

Payment gateway system 104 may include one or more devices capable of receiving information and/or data from merchant system 102, acquirer system 106, transaction service provider system 108, issuer system 110, and/or user device 112 (e.g., via communication network 116, etc.) and/or communicating information and/or data to merchant system 102, acquirer system 106, transaction service provider system 108, issuer system 110, and/or user device 112 (e.g., via communication network 116, etc.). For example, payment gateway system 104 may include a computing device, such as a server, a group of servers, and/or other like devices. In some non-limiting embodiments or aspects, payment gateway system 104 is associated with a payment gateway as described herein.

Acquirer system 106 may include one or more devices capable of receiving information and/or data from merchant system 102, payment gateway system 104, transaction service provider system 108, issuer system 110, and/or user device 112 (e.g., via communication network 116, etc.) and/or communicating information and/or data to merchant system 102, payment gateway system 104, transaction service provider system 108, issuer system 110, and/or user device 112 (e.g., via communication network 116, etc.). For example, acquirer system 106 may include a computing device, such as a server, a group of servers, and/or other like devices. In some non-limiting embodiments or aspects, acquirer system 106 may be associated with an acquirer as described herein.

Transaction service provider system 108 may include one or more devices capable of receiving information and/or data from merchant system 102, payment gateway system 104, acquirer system 106, issuer system 110, and/or user device 112 (e.g., via communication network 116, etc.) and/or communicating information and/or data to merchant system 102, payment gateway system 104, acquirer system 106, issuer system 110, and/or user device 112 (e.g., via communication network 116, etc.). For example, transaction service provider system 108 may include a computing device, such as a server (e.g., a transaction processing server, etc.), a group of servers, and/or other like devices. In some non-limiting embodiments or aspects, transaction service provider system 108 may be associated with a transaction service provider as described herein. In some non-limiting embodiments or aspects, transaction service provider system 108 may include and/or access one or more internal and/or external databases including transaction data.

Issuer system 110 may include one or more devices capable of receiving information and/or data from merchant system 102, payment gateway system 104, acquirer system 106, transaction service provider system 108, and/or user device 112 (e.g., via communication network 116, etc.) and/or communicating information and/or data to merchant system 102, payment gateway system 104, acquirer system 106, transaction service provider system 108, and/or user device 112 (e.g., via communication network 116 etc.). For example, issuer system 110 may include a computing device, such as a server, a group of servers, and/or other like devices. In some non-limiting embodiments or aspects, issuer system 110 may be associated with an issuer institution as described herein. For example, issuer system 110 may be associated with an issuer institution that issued a payment account or instrument (e.g., a credit account, a debit account, a credit card, a debit card, etc.) to a user (e.g., a user associated with user device 112, etc.).

In some non-limiting embodiments or aspects, transaction processing network 101 includes a plurality of systems in a communication path for processing a transaction. For example, transaction processing network 101 can include merchant system 102, payment gateway system 104, acquirer system 106, transaction service provider system 108, and/or issuer system 110 in a communication path (e.g., a communication path, a communication channel, a communication network, etc.) for processing an electronic payment transaction. As an example, transaction processing network 101 can process (e.g., initiate, conduct, authorize, etc.) an electronic payment transaction via the communication path between merchant system 102, payment gateway system 104, acquirer system 106, transaction service provider system 108, and/or issuer system 110.

User device 112 may include one or more devices capable of receiving information and/or data from merchant system 102, payment gateway system 104, acquirer system 106, transaction service provider system 108, and/or issuer system 110 (e.g., via communication network 116, etc.) and/or communicating information and/or data to merchant system 102, payment gateway system 104, acquirer system 106, transaction service provider system 108, and/or issuer system 110 (e.g., via communication network 116, etc.). For example, user device 112 may include a client device and/or the like. In some non-limiting embodiments or aspects, user device 112 may be capable of receiving information (e.g., from merchant system 102, etc.) via a short range wireless communication connection (e.g., an NFC communication connection, an RFID communication connection, a Bluetooth® communication connection, and/or the like), and/or communicating information (e.g., to merchant system 102, etc.) via a short range wireless communication connection. In some non-limiting embodiments or aspects, user device 112 may include an application associated with user device 112, such as an application stored on user device 112, a mobile application (e.g., a mobile device application, a native application for a mobile device, a mobile cloud application for a mobile device, an electronic wallet application, an issuer bank application, and/or the like) stored and/or executed on user device 112. In some non-limiting embodiments or aspects, user device 112 may be associated with a sender account and/or a receiving account in a payment network for one or more transactions in the payment network.

Communication network 116 may include one or more wired and/or wireless networks. For example, communication network 116 may include a cellular network (e.g., a long-term evolution (LTE®) network, a third generation (3G) network, a fourth generation (4G) network, a fifth generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN)), a private network, an ad hoc network, an intranet, the Internet, a fiber optic-based network, a cloud computing network, and/or the like, and/or a combination of these or other types of networks.

The number and arrangement of devices and systems shown in FIG. 1 is provided as an example. There may be additional devices and/or systems, fewer devices and/or systems, different devices and/or systems, or differently arranged devices and/or systems than those shown in FIG. 1. Furthermore, two or more devices and/or systems shown in FIG. 1 may be implemented within a single device and/or system, or a single device and/or system shown in FIG. 1 may be implemented as multiple, distributed devices and/or systems. Additionally or alternatively, a set of devices and/or systems (e.g., one or more devices or systems) of environment 100 may perform one or more functions described as being performed by another set of devices and/or systems of environment 100.

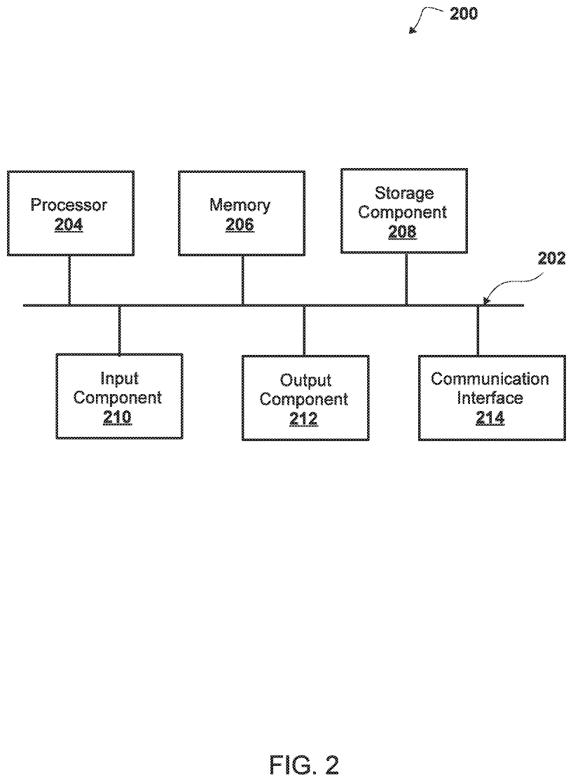

Referring now to FIG. 2, shown is a diagram of example components of a device 200 according to non-limiting embodiments. Device 200 may correspond to merchant system 102, payment gateway system 104, acquirer system 106, transaction service provider system 108, issuer system 110, and/or user device 112, as an example. In some non-limiting embodiments, such systems or devices may include at least one device 200 and/or at least one component of device 200. The number and arrangement of components shown are provided as an example. In some non-limiting embodiments, device 200 may include additional components, fewer components, different components, or differently arranged components than those shown. Additionally, or alternatively, a set of components (e.g., one or more components) of device 200 may perform one or more functions described as being performed by another set of components of device 200.

As shown in FIG. 2, device 200 may include a bus 202, a processor 204, memory 206, a storage component 208, an input component 210, an output component 212, and a communication interface 214. Bus 202 may include a component that permits communication among the components of device 200. In some non-limiting embodiments, processor 204 may be implemented in hardware, firmware, or a combination of hardware and software. For example, processor 204 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 206 may include random access memory (RAM), read only memory (ROM), and/or another type of dynamic or static storage device (e.g., flash memory, magnetic memory, optical memory, etc.) that stores information and/or instructions for use by processor 204.

With continued reference to FIG. 2, storage component 208 may store information and/or software related to the operation and use of device 200. For example, storage component 208 may include a hard disk (e.g., a magnetic disk, an optical disk, a magneto-optic disk, a solid-state disk, etc.) and/or another type of computer-readable medium. Input component 210 may include a component that permits device 200 to receive information, such as via user input (e.g., a touch screen display, a keyboard, a keypad, a mouse, a button, a switch, a microphone, etc.). Additionally, or alternatively, input component 210 may include a sensor for sensing information (e.g., a global positioning system (GPS) component, an accelerometer, a gyroscope, an actuator, etc.). Output component 212 may include a component that provides output information from device 200 (e.g., a display, a speaker, one or more light-emitting diodes (LEDs), etc.). Communication interface 214 may include a transceiver-like component (e.g., a transceiver, a separate receiver and transmitter, etc.) that enables device 200 to communicate with other devices, such as via a wired connection, a wireless connection, or a combination of wired and wireless connections. Communication interface 214 may permit device 200 to receive information from another device and/or provide information to another device. For example, communication interface 214 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 200 may perform one or more processes described herein. Device 200 may perform these processes based on processor 204 executing software instructions stored by a computer-readable medium, such as memory 206 and/or storage component 208. A computer-readable medium may include any non-transitory memory device. A memory device includes memory space located inside of a single physical storage device or memory space spread across multiple physical storage devices. Software instructions may be read into memory 206 and/or storage component 208 from another computer-readable medium or from another device via communication interface 214. When executed, software instructions stored in memory 206 and/or storage component 208 may cause processor 204 to perform one or more processes described herein. Additionally, or alternatively, hardwired circuitry may be used in place of or in combination with software instructions to perform one or more processes described herein. Thus, embodiments described herein are not limited to any specific combination of hardware circuitry and software. The terms “configured to”, “programmed to,” and/or “programmed or configured to,” as used herein, may refer to an arrangement of software, device(s), and/or hardware for performing and/or enabling one or more functions (e.g., actions, processes, steps of a process, and/or the like). For example, “a processor programmed or configured to” may refer to a processor that executes software instructions (e.g., program code) that cause the processor to perform one or more functions.

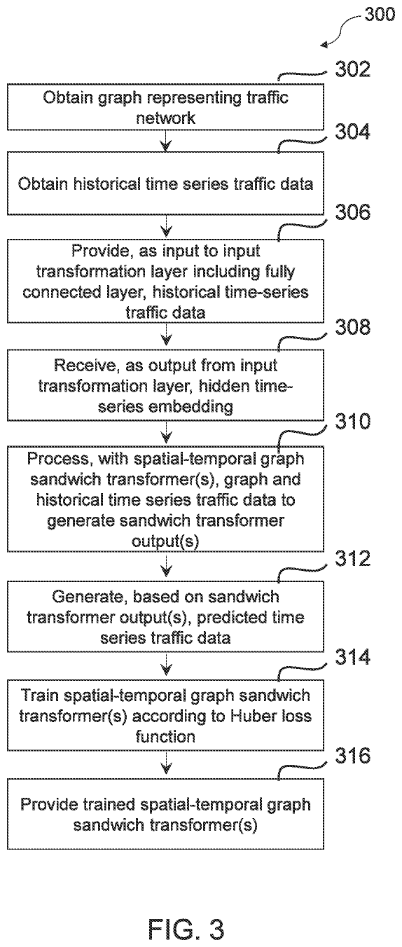

Referring now to FIG. 3, shown is a flow diagram for a method 300 for a spatial-temporal graph sandwich transformer, according to some non-limiting embodiments or aspects. The steps shown in FIG. 3 are for example purposes only. It will be appreciated that additional, fewer, different, and/or a different order of steps may be used in some non-limiting embodiments or aspects. In some non-limiting embodiments or aspects, a step may be automatically performed in response to performance and/or completion of a prior step.

As shown in FIG. 3, at step 302, method 300 includes obtaining a graph representing a traffic network. For example, transaction service provider system 108 may obtain a graph representing a traffic network.

A traffic network can be represented as a graph [symbol] =( [symbol] , ε), where [symbol] denotes a set of N nodes (e.g., sensors, etc.) and ε is a set of edges, indicating the connectivity between nodes. An adjacency matrix derived from the graph may be denoted by A∈ [symbol] , where Aᵢⱼ=1 if (vᵢ, vⱼ).

In some non-limiting embodiments or aspects, the traffic network includes a payment network, the graph [symbol] includes a plurality of edges ε and a plurality of nodes N for the plurality of edges ε, the plurality of nodes N is associated with a plurality of payment processing servers, and/or the plurality of edges ε is associated with a plurality of connections between the plurality of payment processing servers.

As shown in FIG. 3, at step 304, method 300 includes obtaining historical time-series traffic data associated with historical traffic conditions at a number of historical time steps in the traffic network. For example, transaction service provider system 108 may obtain historical time-series traffic data associated with historical traffic conditions at a number of historical time steps in the traffic network.

A traffic condition at time step t can be formulated as X^{(t)}∈ [symbol] , where D indicates the number of traffic measurements (e.g., volume, speed, etc.). Given S step historical traffic conditions [X^{(t-S+1)}, . . . , X^{(t)}], a forecasting model F can be learned to predict the traffic conditions of the future T steps [X″^{(t+1)}, . . . , X′^{(t+T)}], according to the following Equation (1):

$$[ {X}^{( t - 𝒮 + 1 )} , … , {X}^{( t )} ; 𝒢 ] {⟶}^{ℱ} [ {X}^{′ ( t + 1 )} , … , {X}^{′ ( t + T )} ] . \qquad ( 1 )$$

where X^{(t-S+1):(t)}∈ [symbol] and X′^{(t+1):(t+T)}∈ [symbol] denote the input and output, respectively.

In some non-limiting embodiments or aspects, a traffic condition may correspond to processing of one or more payments at one or more payment processing servers in a payment network.

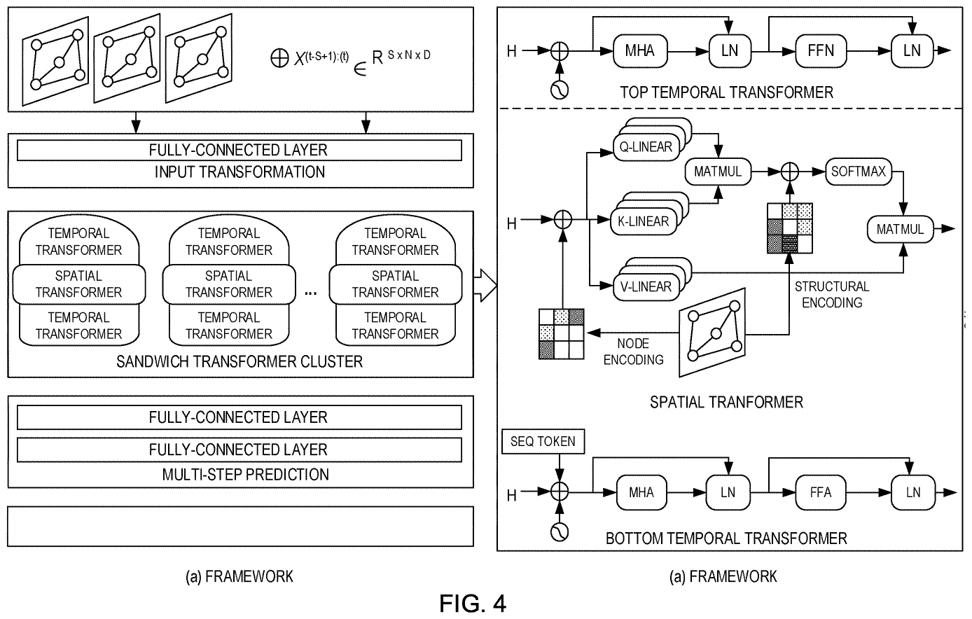

As shown in FIG. 3, at step 306, method 300 includes providing, as an input to an input transformation layer including a fully connected layer, the historical time-series traffic data. For example, transaction service provider system 108 may provide, as an input to an input transformation layer including a fully connected layer, the historical time-series traffic data. As an example, and referring also to FIG. 4, FIG. 4 illustrates an architecture of non-limiting embodiments or aspects of an STGST. As shown in FIG. 4, an STGST may take the input of S steps historical time-series traffic data X^{(t-S+1):(t)}∈ [symbol] and traffic network [symbol] and output the prediction for next T steps X′^{(t+1):(t+T)}∈ [symbol] . The STGST may include the following modules: an input transformation, a sandwich transformer cluster, and a multi-step prediction. The input transformation may include a fully-connected layer projecting low-dimensional traffic data into a high-dimensional informative space.

As shown in FIG. 3, at step 308, method 300 includes receiving, as an output from the input transformation layer, a hidden time-series embedding. For example, transaction service provider system 108 may receive, as an output from the input transformation layer, a hidden time-series embedding. As an example, the input transformation layer may generate the hidden time-series embedding [symbol] ∈ [symbol] , where S, N, and d denote the sequence length, the number of nodes, and the hidden dimension, respectively.

As shown in FIG. 3, at step 310, method 300 includes processing, with each spatial-temporal graph sandwich transformer of at least one spatial-temporal graph sandwich transformer, the graph and the historical time-series traffic data to generate a sandwich transformer output. For example, transaction service provider system 108 may process, with each spatial-temporal graph sandwich transformer of at least one spatial-temporal graph sandwich transformer, the graph and the historical time-series traffic data to generate a sandwich transformer output. As an example, transaction service provider system 108 may process, with each spatial-temporal graph sandwich transformer of at least one spatial-temporal graph sandwich transformer, the hidden time-series embedding received as the output from the input transformation layer.

A Transformer architecture may be composed of a set of Transformer layers as described by Vaswani, A., Shazeer, N., Parmar, N., Uszkoreit, J., Jones, L., Gomez, A. N., Kaiser, L., and Polosukhin, I. in the paper entitled “Attention is all you need”, NIPS 30 (2017), the entire disclosure of which is hereby incorporated by reference in its entirety. Each Transformer layer may include a multi-head attention (MHA) block followed by a point-wise feed-forward (FFN) block, with residual connections and layer normalization (LN) around each. Letting X∈ [symbol] be the input of the Transformer layer, the MHA block may be calculated according to the following Equations (2) and (3):

$$MHA ( X ) = {‖}_{h = 1}^{H} ( Attention ( {Q}_{h} , {K}_{h} , {V}_{h} ) ) {W}^{O} , \qquad ( 2 )$$

$$Attention ( {Q}_{h} , {K}_{h} , {V}_{h} ) = softmax ( \frac{{Q}_{h} {K}_{h}^{⊤}}{\sqrt{d}} ) {V}_{h} . \qquad ( 3 )$$

where

$${Q}_{h} = {XW}_{h}^{Q} , {K}_{h} = {XW}_{h}^{K} , {V}_{h} = {XW}_{h}^{V} , and {W}_{h}^{Q} , {W}_{h}^{K} and {W}_{h}^{V}$$

are the query, key, and value weight matrices that linearly project the input X in h-th attention head.

Residual connection and layer normalization may be further applied to the output of MHA, denoted as \hat{X}=LN(MHA(X)+X). The FFN block may be calculated according to the following Equation (4):

$$FFN ( \hat{X} ) = σ ( \hat{X} {W}_{1} + {b}_{1} ) {W}_{2} + {b}_{2} , \qquad ( 4 )$$

where σ denotes the activation function, W₁, W₂, b₁, and b₂ are weight matrices and biases. The final output of a Transformer layer is \tilde{X}=LN(FFN(\hat{X})+\hat{X}).

Referring now to FIG. 4, which illustrates an architecture of non-limiting embodiments or aspects of an STGST that may take the input of S steps historical time-series traffic data X^{(t-S+1):(t)}∈ [symbol] and traffic network [symbol] and output the prediction for next T steps X′^{(+1):(t+T)}∈ [symbol] , the sandwich transformer cluster may include at least one spatial-temporal graph sandwich transformer and/or a set of spatial-temporal graph sandwich transformers (e.g., a plurality of spatial-temporal graph sandwich transformers, etc.). Each spatial-temporal graph sandwich transformer may include a top temporal transformer, a spatial transformer that receives, as an input, an output of the top temporal transformer and the graph, and a bottom temporal transformer that receives, as an input, an output of the spatial transformer. For example, each spatial-temporal graph sandwich transformer may include two temporal transformers as “buns” and a spatial transformer as “meat”. As an example, each spatial-temporal graph sandwich transformer in the sandwich transformer cluster may include a combination of a top temporal transformer, a spatial transformer, and a bottom temporal transformer in a “sandwich” manner. The temporal and spatial transformers may characterize long-range temporal dependency and deep spatial dependency individually, and/or the sandwich combination may capture prosperous spatial-temporal interactions. The cluster of sandwich transformers may further strengthen such connections and/or the spatial-temporal graph sandwich transformers may be executed in parallel to speed up a training process. For example, processing, with each spatial-temporal graph sandwich transformer, the graph and the historical time-series traffic data to generate the sandwich transformer output may be performed in parallel with the plurality of spatial-temporal graph sandwich transformers. In multi-step prediction, the sandwich transformer cluster outputs may be first concatenated and then fed into two fully-connected layers to generate the forecasting results.

In some non-limiting embodiments or aspects, processing, with each spatial-temporal graph sandwich transformer, the graph and the historical time-series traffic data to generate the sandwich transformer output includes: applying, with the top temporal transformer, to an input of the top temporal transformer, a multi-head attention followed by a feed-forward network, with a residual connection and a layer normalization around each of the multi-head attention and the feed-forward network. For example, the top temporal transformer may be performed on each node in the traffic network, aiming to characterize the long-range temporal dependency of the time-series input in the temporal dimension. Given the hidden time-series embedding [symbol] ∈ [symbol] generated from the input transformation module, where [symbol] , N, and d denote the sequence length, the number of nodes, and the hidden dimension, respectively, the top temporal transformer module, which may denoted as XFMRₜₒₚ(·), can be formulated according to the following Equation (5):

$${ℋ}^{𝒯} = {XFMR}_{top} ( ℋ ; {Θ}_{top} ) \qquad ( 5 )$$

where [symbol] is the outputs having the same size of [symbol] , and Θₜₒₚ is the trainable parameters. The dimension N may be treated as batchsize in this module.

The design of XFMR(·) may be built upon the Transformer architecture as described by Vaswani, A., Shazeer, N., Parmar, N., Uszkoreit, J., Jones, L., Gomez, A. N., Kaiser, L., and Polosukhin, I. in the paper entitled “Attention is all you need”, NIPS 30 (2017), the entire disclosure of which is hereby incorporated by reference in its entirety. Given a node with its hidden time-series embedding H∈ [symbol] fetched from [symbol] , before calculating the MHA, time encoding Eₜᵢₘₑ∈ [symbol] may be added into the hidden time-series embedding H to incorporate the time-related factors of time-series input. Each element p(t, i)(1≤t≤ [symbol] and 1≤i≤d) in Eₜᵢₘₑ may be derived from a frequency encoding function that characterizes a time-dependent sinusoid. For example, p(t, i)=sin(t/10000^{2i/d}) if i is even, or cos (t/10000^{2i/d}) if i is odd.

By adding the time encoding into the hidden embedding at different time steps, the hidden embeddings may become discriminative with regard to time, and/or the Transformer encoder architecture may be followed to learn the temporal dependency, which may be formulated according to the following Equation (6):

$$\begin{matrix}{H}^{′} = H + {E}_{time} , \\ \hat{H} = L N ( MHA ( {H}^{′} ) + {H}^{′} ) , \\ {H}^{𝒯} = L N ( FFN ( \hat{H} ) + \hat{H} ) .\end{matrix} \qquad ( 6 )$$

where gathering outputs of each node forms [symbol] .

In some non-limiting embodiments or aspects, processing, with each spatial-temporal graph sandwich transformer, the graph and the historical time-series traffic data to generate the sandwich transformer output includes: applying, with the spatial transformer, to the input to the spatial transformer including the output of the top temporal transformer and the graph, degree-based encoding and singular value decomposition (SVD)-based encoding; and applying, with the spatial transformer, spatial encoding as a bias term in a multi-headed attention applied to the input to the spatial transformer including the output of the top temporal transformer and the graph. For example, different from the temporal transformer, the spatial transformer may be conducted on each time step, aiming to describe the global spatial dependency across all the nodes in the traffic network in this time step. Given the traffic network [symbol] and the output from last component [symbol] ∈ [symbol] , the spatial transformer XFMRₛₚₐ(·) may be defined according to the following Equation (7):

$${ℋ}^{𝒯𝒮} = {XFMR}_{spa} ( {ℋ}^{𝒯} , 𝒢 ; {Θ}_{spa} ) , \qquad ( 7 )$$

where the output [symbol] has the same size as [symbol] , and Θₛₚₐ is the learnable parameters. The dimension S may be regarded as batchsize in the spatial transformer when describing the spatial dependency of N nodes.

According to an observation described by Min, E., Chen, R., Bian, Y., Xu, T., Zhao, K., Huang, W., Zhao, P., Huang, J., Ananiadou, S., and Rong, Y. in the paper entited “Transformer for graphs: An overview from architecture perspective”, arXiv preprint arXiv:2202.08455 (2022), the entire disclosure of which is hereby incorporated by reference in its entirety, non-limiting embodiments or aspects may introduce two strategies to encode the graph structural information into the transformer architecture. For example, non-limiting embodiments or aspects may add degree-based encoding and singular value decomposition (SVD)-based encoding into the input and add spatial encoding as a bias term in the MHA module. By performing these two structure-preserving strategies, the transformer layer may adaptively adjust the attention coefficient according to the graph structural information. For example, the positional encoding E_{struc} added into the input may be formulated according to the following Equation (8):

$${E}_{struc} = {E}_{deg} + {E}_{svd} , \qquad ( 8 )$$

Where E_{deg}, E_{svd}∈ [symbol] denote the degree-based encoding and SVD-based encoding. E_{deg} may be represented as a sum of Eᵢₙ and Eₒᵤₜ, which may be learnable matrices identified by the indegree and outdegree, respectively. E_{svd} may be added to further distinguish two nodes with the same degree and may be formed using the largest r singular values and corresponding left and right singular vectors according to the following Equation (9):

$$\begin{matrix}A {\approx }^{SVD} U Σ {V}^{⊤} = ( U \sqrt{Σ} ) \cdot {( V \sqrt{Σ} )}^{⊤} = \hat{U} {\hat{V}}^{⊤} , \\ {E}_{svd} = \hat{U} ‖ \hat{V} ,\end{matrix} \qquad ( 9 )$$

where U, V∈ [symbol] includes the r left and right singular vectors, respectively, corresponding to the top r singular values in the diagonal matrix Σ∈ [symbol] , ∥ denotes concatenation operator along column.

The spatial encoding E_{spd} may be defined based on the concept of shortest path. Each element in E_{spd} may denote the distance of the shortest path (SPD) between two corresponding nodes. The spatial encoding may serve as a bias term in the MHA module according to the following Equation (10):

$$Attention ( Q , K , V ) = softmax ( \frac{{QK}^{⊤}}{\sqrt{d}} + {E}_{spd} ) V . \qquad ( 10 )$$

The indegree and outdegree of each node, the SVD vectors, and the SPD between two connected nodes may be pre-computed before model training, which may not largely impact the training time and the used resources. Given a time step with the hidden embedding [symbol] ∈ [symbol] for all nodes, the spatial dependency may be formulated according to the following Equation (11):

$$\begin{matrix}{H}^{′𝒯} = {H}^{𝒯} + {E}_{struc} , \\ {\hat{H}}^{𝒯} = L N ( MHA ( {H}^{′𝒯} , {E}_{spd} ) + {H}^{′𝒯} ) , \\ {H}^{𝒯𝒮} = L N ( FFN ( {\hat{H}}^{𝒯} ) + {\hat{H}}^{𝒯} ) .\end{matrix} \qquad ( 11 )$$

where stacking the output of S time steps may result in [symbol] .

In some non-limiting embodiments or aspects, the input to the bottom temporal transformer including the output of the spatial transformer incudes a plurality of time-series sequences, and processing, with each spatial-temporal graph sandwich transformer, the graph and the historical time-series traffic data to generate the sandwich transformer output includes: appending, with the bottom temporal transformer, a special token to a beginning of each time-series sequence of the plurality of time-series sequences; and applying, with the bottom temporal transformer, to a plurality of token-appended time-series sequences, a multi-head attention followed by a feed-forward network, with a residual connection and a layer normalization around each of the multi-head attention and the feed-forward network. For example, another temporal transformer may be connected to the spatial transformer to capture the spatial-temporal interactions. Taking [symbol] ∈ [symbol] as input, the bottom temporal transformer XFMR_{bottom}(·) may be defined according to the following Equation (12):

$${ℋ}^{𝒯𝒮𝒯} = {XFMR}_{bottom} ( {ℋ}^{𝒯𝒮} ; {Θ}_{bottom} ) , \qquad ( 12 )$$

where [symbol] ∈ [symbol] , and Θ_{bottom} is the trainable parameters for the bottom temporal transformer module. The general design of the bottom temporal transformer module may be the same as or similar to the top temporal transformer, including time encoding, MHA and FFN; however, in the bottom temporal transformer module, a special token [SEQ] may be appended to the beginning of each time-series sequence, summarizing the sequence-level representation.

As shown in FIG. 3, at step 312, method 300 includes generating, based on the sandwich transformer output from each spatial-temporal graph sandwich transformer, predicted time-series traffic data associated with predicted traffic conditions at a number of next time steps in the traffic network. For example, transaction service provider system 108 may generate, based on the sandwich transformer output from each spatial-temporal graph sandwich transformer, predicted time-series traffic data associated with predicted traffic conditions at a number of next time steps in the traffic network.

In some non-limiting embodiments or aspects, generating, based on the sandwich transformer output from each spatial-temporal graph sandwich transformer, the predicted time-series traffic data associated with the predicted traffic conditions at the number of next time steps in the traffic network includes: concatenating the sandwich transformer output from each spatial-temporal graph sandwich transformer; providing, as an input to a multi-step prediction layer including at least two fully connected layers, the concatenated sandwich transformer output from each spatial-temporal graph sandwich transformer; and receiving, as an output from the multi-step prediction layer, the predicted time-series traffic data associated with the predicted traffic conditions at the number of next time steps in the traffic network. For example, and referring again to FIG. 4, the embedding of [SEQ] token H_{seq} may be fetched from [symbol] as the output of each sandwich transformer. By concatenating the output of the sandwich transformer cluster including K spatial-temporal graph sandwich transformers, provided is where

$${H}^{O} = {‖}_{k = 1}^{K} {H}_{seq}^{k} ,$$

where H^{O}∈ [symbol] . A two-layer MLP may be provided as an output layer to make a final prediction.

As shown in FIG. 3, at step 314, method 300 includes training the at least one spatial-temporal graph sandwich transformer according to a Huber loss function. For example, transaction service provider system 108 may train the at least one spatial-temporal graph sandwich transformer (e.g., train an STGST, etc.) according to a Huber loss function that depends on the predicted time-series traffic data associated with the predicted traffic conditions at the number of next time steps in the traffic network and actual time-series traffic data associated with actual traffic conditions at the number of next time steps in the traffic network. As an example, a Huber loss defined according to the following Equation (13) may be selected as the loss function because the Huber loss is less sensitive to outliers than the squared error loss:

$$ℒ = \{ \begin{matrix}\frac{1}{2} {( {𝒳}^{′} - 𝒴 )}^{2} , & if \vert {𝒳}^{′} - 𝒴 \vert < δ \\ δ ( \vert {𝒳}^{′} - 𝒴 \vert - \frac{1}{2} δ ) , & otherwise\end{matrix} \qquad ( 13 )$$

where y is the actual traffic flow, and & controls the sensitivity to outliers.

As shown in FIG. 3, at step 316, method 300 includes providing the trained at least one spatial-temporal graph sandwich transformer. For example, transaction service provider system 108 may provide the trained at least one spatial-temporal graph sandwich transformer (e.g., provide the trained STGST, etc.). As an example, transaction service provider system 108 may store (e.g., in memory, in a database, etc.) the trained at least one spatial-temporal graph sandwich transformer (e.g., the trained STGST, etc.). In such an example, transaction service provider system 108 may apply the trained STGST to an input of [symbol] steps historical time-series traffic data X^{(t-S+1):(t)}∈ [symbol] and traffic network [symbol] and receive, as output from the STGST, a prediction for a next T steps X′^{(t+1):(t+T)}∈ [symbol] of traffic data or traffic conditions (e.g., for next traffic conditions in a payment network, etc.).

### Experiments

In this section, a performance of non-limiting embodiments or aspects of an STGST is compared with state-of-the-art baselines on public traffic network benchmarks with an aim to answer the following research questions: RQ1. How does STGST perform in traffic flow prediction tasks?; RQ2. How does each component of STGST contribute to the prediction?; and RQ3. How is the learning stability of STGST? And how do certain hyperparameters impact the model performance?

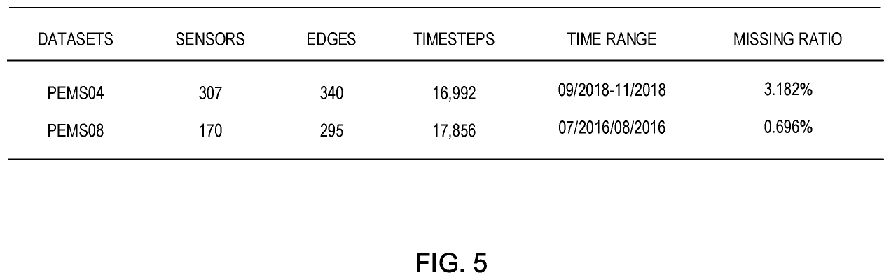

Non-limiting embodiments or aspects of an STGST may be validated on the real-world highway traffic data initially collected by the Caltrans Performance Measurement System (PeMS) in real-time every 30 seconds as described by Chen, C., Petty, K., Skabardonis, A., Varaiya, P., and Jia, Z. in the paper entitled “Freeway performance measurement system: mining loop detector data”, Transportation Research Record 1748(1), 96-102 (2001), the entire disclosure of which is hereby incorporated by reference in its entirety. FIG. 5 is a table of dataset statistics of two traffic datasets selected for the experiments, PeMS04 and PeMS08, which have been widely studied in the traffic flow forecasting domain and are described and released by Song, C., Lin, Y., Guo, S., and Wan, H. in the paper entitled “Spatial-temporal synchronous graph convolutional networks: A new framework for spatial-temporal network data forecasting”, In: AAAI. vol. 34, pp. 914-921 (2020), the entire disclosure of which is hereby incorporated by reference in its entirety. The traffic data, including flow, speed, and occupancy, is aggregated every 5 minutes, and the Z-score normalization is adopted to standardize the data inputs. The spatial relations are constructed according to the actual road network.

Non-limiting embodiments or aspects of an STGST are compared with three types of state-of-the-art baselines, including an RNN-based model, a convolution-based model, and a spatial-temporal graph based model. LSTM and TCN are selected for the first two categories and STG2Seq, STGCN, DCRNN, GraphWaveNet, STSGCN, ASTGCN, MSTGCN, and STGODE are selected for the third category.

Following the standard benchmark setting in this domain, each dataset is split into a training set, a validation set and a test set with a ratio of 6:2:2 in chronological order. One-hour historical data is used to forecast the next hour's data, which means using the past 12 continuous time steps to predict the future 12 continuous time steps. The mean absolute error (MAE), mean absolute percentage error (MAPE), and root mean squared error (RMSE) are used to measure the performance.

Non-limiting embodiments or aspects of an STGST may be implemented using Python 3.9.13, Py-Torch 1.12.1 and DGL (Deep Graph Library) 0.9.1. All experiments are conducted on a Linux server equipped with Intel (R) Xeon (R) Gold 6130 CPU and NVIDIA Tesla V100 GPU. The hidden dimension is set to 128, the number of attention heads is set to 8, the dropout rate is set to 0.1, the number of sandwich transformers is set to 2, the number of temporal transformer layers and spatial transformer layers is set to 4 and 3 for PEMS04 and PEMS08, respectively, according to the graph scale in each dataset. The STGST is trained for 200 epochs using an Adam optimizer with a batch size of 32, a learning rate of 3e-4 and a weight decay of 5e-4. For reproducibility, the random seed is set to 0.

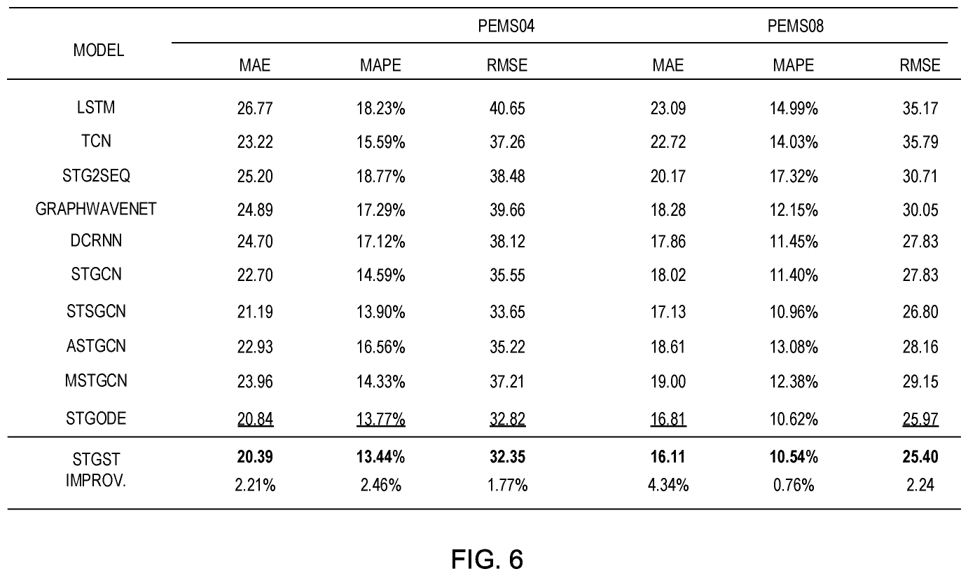

FIG. 6 is a table including a comparison of performance between non-limiting embodiments or aspects of an STGST and baselines. The forecasting errors of STGST and the ten baselines on the PEMS04 and PEMS08 datasets are shown in FIG. 6 with the best and second best results for each dataset are highlighted in bold and underlined. By comparing the results of LSTM and TCN with other baselines, it can be seen that spatial-temporal graph models considering both time and space dependencies achieve better performance than sequence models that only capture temporal information. This further confirms the benefit of spatial dependency in traffic flow forecasting. From the results, it can also be observed that STGST consistently outperforms all baselines on both datasets in terms of three evaluation metrics. The last row of the table in FIG. 6 shows the improvement of STGST over the most competitive baseline, i.e., STGODE. On average, STGST has a 3.28%, 1.61%, and 2.01% performance gain over STGODE on MAE, MAPE and RMSE, respectively. The superior performance comes from the well-designed spatial-temporal graph sandwich transformer, which is able to capture long-range temporal and deep spatial dependencies and describe prosperous spatial-temporal interactions.

To verify the contribution of each module of STGST in the prediction task, three STGST variants are prepared and ablation studies are conducted on both datasets. The “w/o Temporal” variant removes two temporal transformers and adds an average pooling layer to the outputs of spatial transformer. The “w/o Spatial” variant removes the spatial transformer module and connects two temporal transformers directly. The “w/o Encoding” variant removes the spatial positional encoding module, e.g., the degree encoder and the SVD encoder, in the spatial transformer.

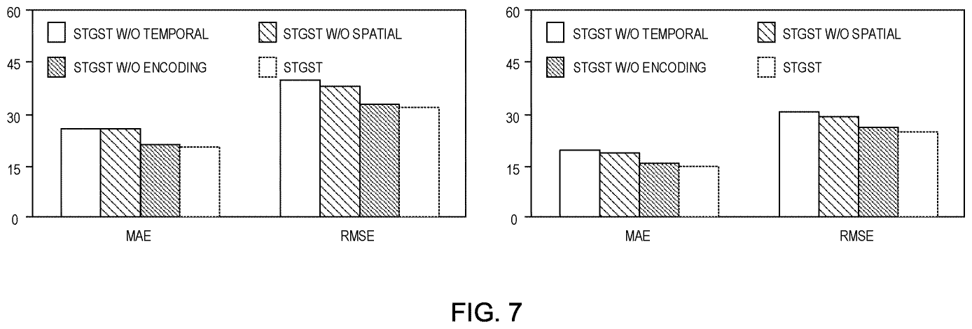

FIG. 7 is graphs of a comparison of performance between STGST variants. As shown in FIG. 7, STGST equipped with all designed components outperforms its three variants, proving that each component contributes to the final performance. By comparing STGST with w/o Temporal and w/o Spatial, it can be seen that ignoring either the spatial domain or temporal domain greatly deteriorates the performance. Moreover, the w/o Spatial variant achieves slightly better performance than the w/o Temporal variant, indicating the advantage of temporal dependency over spatial dependency in traffic flow prediction. In addition, spatial positional encoding helps capture the spatial dependency, which can be observed from the results of the w/o Encoding variant and STGST.

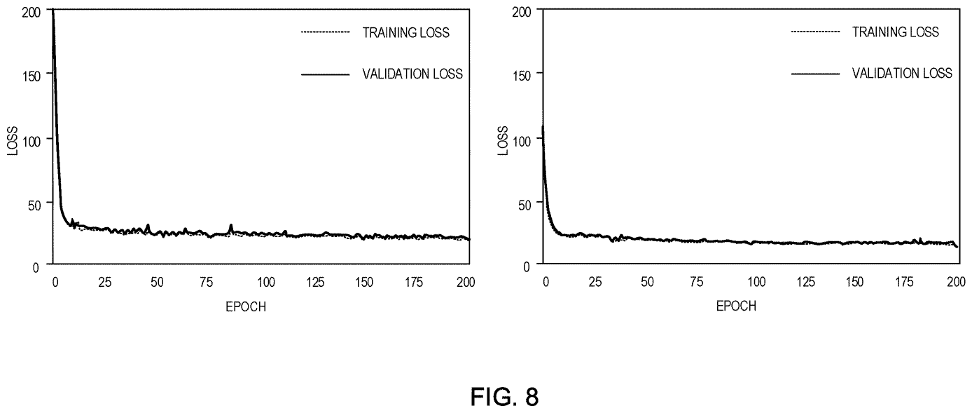

The learning stability of STGST is now investigated. The curves of training loss and validation loss of STGST on the two traffic datasets selected for experiments are plotted in FIG. 8. Analyzing the curves in both datasets, it is noted that STGST quickly converges at epoch 8 and 5 on PEMS04 and PEMS08, respectively, and the loss smoothly decreases along with the epoch. This finding indicates that the learning procedure of STGST is stable. It can also be seen that the validation loss is slightly over the training loss curve, which means the trained model can be well generalized to the validation set, and the learning does not encounter overfitting and underfitting phenomenons.

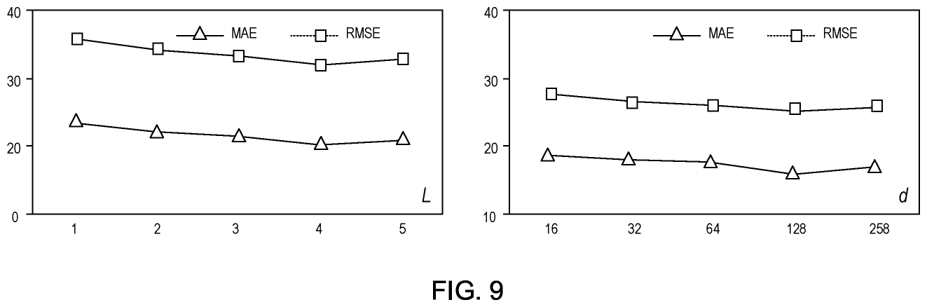

How different choices of parameters affect the model performance is now investigated. The model depth (e.g., the number of transformer encoders, etc.) is varied from 1 to 5 to study the STGST's performance on PEMS04 dataset. The experimental results are shown in FIG. 9 (left). From the curve, it can be seen that with the increase of model depth, the performance first improves and then starts to decrease gradually. The best results are achieved when the model depth is set to 4 on PEMS04. The embedding dimension may be varied from 16 to 256 to investigate its influence. As illustrated in FIG. 9 (right), the effect of the hidden dimension has a similar pattern to model depth, and the best performance is obtained when setting the hidden dimension to 128.

Accordingly, non-limiting embodiments or aspects of the present disclosure may provide an STGST including an input transformation module that projects the time-series input into high-dimensional feature space, a sandwich transformer cluster that processes the temporal dependency and spatial dependency and captures the spatial-temporal interactions, and/or a multi-step prediction module that maps the hidden representations to the output space. The sandwich transformer cluster may be multiple spatial-temporal graph sandwich transformers, each containing a top temporal transformer and a bottom temporal transformer as “buns” and a spatial transformer as “meat,” which enable spatial-temporal interactions to be comprehensively captured comprehensively, thereby providing superior performance over state-of-the-art baselines.

Although embodiments have been described in detail for the purpose of illustration, it is to be understood that such detail is solely for that purpose and that the disclosure is not limited to the disclosed embodiments or aspects, but, on the contrary, is intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect. In fact, any of these features can be combined in ways not specifically recited in the claims and/or disclosed in the specification. Although each dependent claim listed below may directly depend on only one claim, the disclosure of possible implementations includes each dependent claim in combination with every other claim in the claim set.

What is claimed is:

1. A method, comprising:
obtaining, with at least one processor, a graph representing a traffic network;
obtaining, with the at least one processor, historical time-series traffic data associated with historical traffic conditions at a number of historical time steps in the traffic network;
processing, with the at least one processor, with each spatial-temporal graph sandwich transformer of at least one spatial-temporal graph sandwich transformer, the graph and the historical time-series traffic data to generate a sandwich transformer output, wherein each spatial-temporal graph sandwich transformer includes a top temporal transformer, a spatial transformer that receives, as an input, an output of the top temporal transformer and the graph, and a bottom temporal transformer that receives, as an input, an output of the spatial transformer; and
generating, with the at least one processor, based on the sandwich transformer output from each spatial-temporal graph sandwich transformer, predicted time-series traffic data associated with predicted traffic conditions at a number of next time steps in the traffic network.

2. The method of claim 1, wherein the at least one spatial-temporal graph sandwich transformer includes a plurality of spatial-temporal graph sandwich transformers.

3. The method of claim 2, wherein the processing, with the at least one processor, with each spatial-temporal graph sandwich transformer, the graph and the historical time-series traffic data to generate the sandwich transformer output is performed in parallel with the plurality of spatial-temporal graph sandwich transformers.

4. The method of claim 2, further comprising:
providing, with the at least one processor, as an input to an input transformation layer including a fully connected layer, the historical time-series traffic data; and
receiving, with the at least one processor, as an output from the input transformation layer, a hidden time-series embedding, wherein the top temporal transformer of each spatial-temporal graph sandwich transformer receives, as an input, the hidden time-series embedding.

5. The method of claim 2, wherein the generating, with the at least one processor, based on the sandwich transformer output from each spatial-temporal graph sandwich transformer, the predicted time-series traffic data associated with the predicted traffic conditions at the number of next time steps in the traffic network includes:
concatenating the sandwich transformer output from each spatial-temporal graph sandwich transformer;
providing, as an input to a multi-step prediction layer including at least two fully connected layers, the concatenated sandwich transformer output from each spatial-temporal graph sandwich transformer; and
receiving, as an output from the multi-step prediction layer, the predicted time-series traffic data associated with the predicted traffic conditions at the number of next time steps in the traffic network.

6. The method of claim 1, wherein the processing, with the at least one processor, with each spatial-temporal graph sandwich transformer, the graph and the historical time-series traffic data to generate the sandwich transformer output includes:
applying, with the top temporal transformer, to an input of the top temporal transformer, a multi-head attention followed by a feed-forward network, with a residual connection and a layer normalization around each of the multi-head attention and the feed-forward network.

7. The method of claim 1, wherein the processing, with the at least one processor, with each spatial-temporal graph sandwich transformer, the graph and the historical time-series traffic data to generate the sandwich transformer output includes:
applying, with the spatial transformer, to the input to the spatial transformer including the output of the top temporal transformer and the graph, degree-based encoding and singular value decomposition (SVD)-based encoding; and
applying, with the spatial transformer, spatial encoding as a bias term in a multi-headed attention applied to the input to the spatial transformer including the output of the top temporal transformer and the graph.

8. The method of claim 1, wherein the input to the bottom temporal transformer including the output of the spatial transformer incudes a plurality of time-series sequences, and wherein the processing, with the at least one processor, with each spatial-temporal graph sandwich transformer, the graph and the historical time-series traffic data to generate the sandwich transformer output includes:
appending, with the bottom temporal transformer, a special token to a beginning of each time-series sequence of the plurality of time-series sequences; and
applying, with the bottom temporal transformer, to a plurality of token-appended time-series sequences, a multi-head attention followed by a feed-forward network, with a residual connection and a layer normalization around each of the multi-head attention and the feed-forward network.

9. The method of claim 1, further comprising:
training, with the at least one processor, the at least one spatial-temporal graph sandwich transformer according to a Huber loss function that depends on the predicted time-series traffic data associated with the predicted traffic conditions at the number of next time steps in the traffic network and actual time-series traffic data associated with actual traffic conditions at the number of next time steps in the traffic network.

10. The method of claim 1, wherein the traffic network includes a payment network, wherein the graph includes a plurality of edges and a plurality of nodes for the plurality of edges, wherein the plurality of nodes is associated with a plurality of payment processing servers, and wherein the plurality of edges is associated with a plurality of connections between the plurality of payment processing servers.

11. A system, comprising:
at least one processor coupled to a memory and programmed or configured to:
obtain a graph representing a traffic network;
obtain historical time-series traffic data associated with historical traffic conditions at a number of historical time steps in the traffic network;
process, with each spatial-temporal graph sandwich transformer of at least one spatial-temporal graph sandwich transformer, the graph and the historical time-series traffic data to generate a sandwich transformer output, wherein each spatial-temporal graph sandwich transformer includes a top temporal transformer, a spatial transformer that receives, as an input, an output of the top temporal transformer and the graph, and a bottom temporal transformer that receives, as an input, an output of the spatial transformer; and
generate, based on the sandwich transformer output from each spatial-temporal graph sandwich transformer, predicted time-series traffic data associated with predicted traffic conditions at a number of next time steps in the traffic network.

12. The system of claim 11, wherein the at least one spatial-temporal graph sandwich transformer includes a plurality of spatial-temporal graph sandwich transformers, wherein the at least one processor is programmed or configured to process, with each spatial-temporal graph sandwich transformer, the graph and the historical time-series traffic data to generate the sandwich transformer output in parallel with the plurality of spatial-temporal graph sandwich transformers.

13. The system of claim 12, wherein the at least one processor is further programmed or configured to:
provide, as an input to an input transformation layer including a fully connected layer, the historical time-series traffic data; and
receive, as an output from the input transformation layer, a hidden time-series embedding, wherein the top temporal transformer of each spatial-temporal graph sandwich transformer receives, as an input, the hidden time-series embedding.

14. The system of claim 12, wherein the at least one processor is programmed or configured to generate, based on the sandwich transformer output from each spatial-temporal graph sandwich transformer, the predicted time-series traffic data associated with the predicted traffic conditions at the number of next time steps in the traffic network by:
concatenating the sandwich transformer output from each spatial-temporal graph sandwich transformer;
providing, as an input to a multi-step prediction layer including at least two fully connected layers, the concatenated sandwich transformer output from each spatial-temporal graph sandwich transformer; and
receiving, as an output from the multi-step prediction layer, the predicted time-series traffic data associated with the predicted traffic conditions at the number of next time steps in the traffic network.

15. The system of claim 11, wherein the at least one processor is programmed or configured to process, with each spatial-temporal graph sandwich transformer, the graph and the historical time-series traffic data to generate the sandwich transformer output by:
applying, with the top temporal transformer, to an input of the top temporal transformer, a multi-head attention followed by a feed-forward network, with a residual connection and a layer normalization around each of the multi-head attention and the feed-forward network.

16. The system of claim 11, wherein the at least one processor is programmed or configured to process, with each spatial-temporal graph sandwich transformer, the graph and the historical time-series traffic data to generate the sandwich transformer output by:
applying, with the spatial transformer, to the input to the spatial transformer including the output of the top temporal transformer and the graph, degree-based encoding and singular value decomposition (SVD)-based encoding; and
applying, with the spatial transformer, spatial encoding as a bias term in a multi-headed attention applied to the input to the spatial transformer including the output of the top temporal transformer and the graph.

17. The system of claim 11, wherein the input to the bottom temporal transformer including the output of the spatial transformer incudes a plurality of time-series sequences, and wherein the at least one processor is programmed or configured to process, with each spatial-temporal graph sandwich transformer, the graph and the historical time-series traffic data to generate the sandwich transformer output by:
appending, with the bottom temporal transformer, a special token to a beginning of each time-series sequence of the plurality of time-series sequences; and
applying, with the bottom temporal transformer, to a plurality of token-appended time-series sequences, a multi-head attention followed by a feed-forward network, with a residual connection and a layer normalization around each of the multi-head attention and the feed-forward network.

18. The system of claim 11, wherein the at least one processor is further programmed or configured to:
train the at least one spatial-temporal graph sandwich transformer according to a Huber loss function that depends on the predicted time-series traffic data associated with the predicted traffic conditions at the number of next time steps in the traffic network and actual time-series traffic data associated with actual traffic conditions at the number of next time steps in the traffic network.

19. The system of claim 11, wherein the traffic network includes a payment network, wherein the graph includes a plurality of edges and a plurality of nodes for the plurality of edges, wherein the plurality of nodes is associated with a plurality of payment processing servers, and wherein the plurality of edges is associated with a plurality of connections between the plurality of payment processing servers.

20. A computer program product including a non-transitory computer readable medium including program instructions which, when executed by at least one processor, cause the at least one processor to:
obtain a graph representing a traffic network;
obtain historical time-series traffic data associated with historical traffic conditions at a number of historical time steps in the traffic network;
process, with each spatial-temporal graph sandwich transformer of at least one spatial-temporal graph sandwich transformer, the graph and the historical time-series traffic data to generate a sandwich transformer output, wherein each spatial-temporal graph sandwich transformer includes a top temporal transformer, a spatial transformer that receives, as an input, an output of the top temporal transformer and the graph, and a bottom temporal transformer that receives, as an input, an output of the spatial transformer; and
generate, based on the sandwich transformer output from each spatial-temporal graph sandwich transformer, predicted time-series traffic data associated with predicted traffic conditions at a number of next time steps in the traffic network.
